(19) United States
(12) Patent Application Publication
(10) Pub. No.: US 2006/0188740 A1
(43) Pub. Date: Aug. 24, 2006

(54) Composite panel and method of making the same

(76) Inventor: Yi-Che Kuan, Taichung City (TW)

Correspondence Address: NIXON & VANDERHYE, PC, 901 NORTH GLEBE ROAD, 11TH FLOOR, ARLINGTON, VA, 22203, US

(21) Appl. No.: 11/212,600

(22) Filed: Aug. 29, 2005

(30) Foreign Application Priority Data
Feb. 18, 2005 (TW) 094104857

(51) Int. Cl. B32B 13/00; B28B 3/00

(52) U.S. Cl. 428/537.1; 428/703; 264/122; 264/333; 264/102; 264/279

(57) ABSTRACT

A composite panel comprises a wood fiber plate which includes wood fibers, calcium chloride, a fire retarding agent, and a concrete cement; and a cement layer connected to the wood fiber plate, and containing a concrete cement and a resin. A method for making the composite panel is also disclosed.

### BACKGROUND OF THE INVENTION

1. Field of the Invention

This invention relates to a composite panel for buildings, more particularly to a light-weight composite panel containing wood fibers.

2. Description of the Related Art

Building structures, such as building walls, are generally constructed by bricking or forming concrete, followed by application of a concrete cement to the outer surfaces of the building structures for flattening and finishing. However, bricking is laborious as bricks have to be stacked one by one. Forming concrete is time-consuming and laborious as it is necessary to erect mold panels, to pour and solidify a concrete cement, and to disassemble the mold panels. Furthermore, brick walls or concrete walls are generally thick and occupy a lot of space or area so that they are not suitable for use as partitions for buildings, especially those having limited spaces.

Light-weight panels have been commonly used in the construction of partition walls, in place of brick walls and concrete walls. In use, a plurality of light-weight panels are assembled to form a core component, and a concrete cement is applied to two outer surfaces of the core component to finish a partition wall. Assembly of such light-weight panels reduces time and labor and requires less space compared to bricking and concrete-forming.

The aforesaid light-weight panels are typically provided with fire-retarding, sound-insulating, and heat-insulating properties. One of the commonly used light-weight panels is a calcium silicate panel which has excellent fire-resistance. However, the calcium silicate panel is expensive and has poor sound-absorbing property.

Another type of the light-weight panel is a wood-a concrete cement composite panel which is fabricated by dipping wood fibers in a calcium chloride liquid for antisepsis purposes and for the lowering of firing points. The wood fibers are then mixed with a concrete cement and molded. In such a panel, the wood fibers are used to provide sound-absorbing and heat-insulating (low heat conductivity) properties. However, the hardness and the fire-resistance thereof are not as high as those of bricks, concrete, or calcium silicate panels. Moreover, in assembly, it is necessary to apply a thick layer of cement to the composite panel in order to increase strength and fire-resistance. Therefore, assembly of this type of composite panel is also time-consuming and laborious.

### SUMMARY OF THE INVENTION

The object of the present invention is to provide a heat-resistant, sound absorbing, fire-resistant composite panel through which a building wall can be constructed easily without consuming much time and labor.

According to the present invention, a composite panel comprises: a wood fiber plate including wood fibers, calcium chloride, a fire-retarding agent, and a concrete cement; and a cement layer connected to the wood fiber plate and containing a concrete cement, and a resin.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a composite panel embodying the present invention;

FIG. 2 is a rear view of the composite panel;

FIG. 3 is a perspective view showing the composite panel in a state of use;

FIG. 4 is a flow diagram illustrating a method of making the composite panel; and

FIG. 5 is the same view as FIG. 1, but with a cement layer of the composite panel provided with decorative protrusions.

### DETAILED DESCRIPTION OF THE PREFERRED EMBODIMENTS

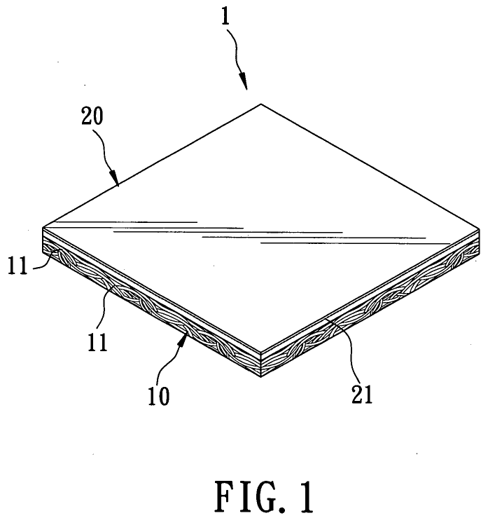

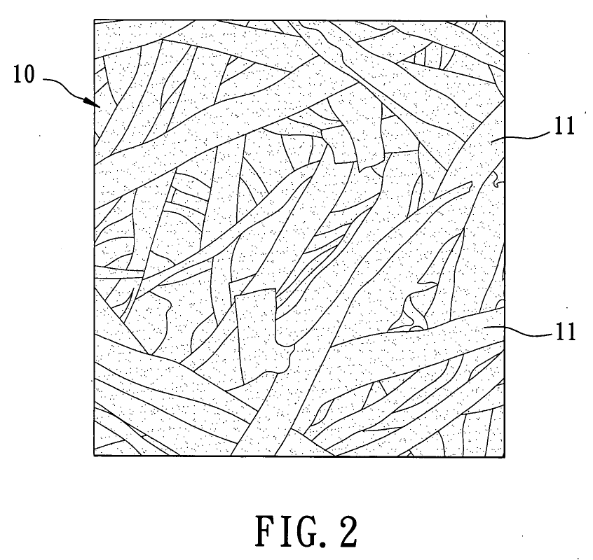

Referring to FIGS. 1 and 2, a composite panel 1 embodying the present invention includes a wood fiber plate 10 and a cement layer 20.

The wood fiber plate 10 is made of wood fibers 11 which are blended with calcium chloride, a fire-retarding agent and a concrete cement. The wood fibers 11 may be obtained by extracting fibers from soft woods in a conventional manner. Examples of soft woods are palm and coconut trees.

The fire-retarding agent may be any fire-retarding agent conventionally used to treat woods for providing fire-retarding properties. However, a natural fire-retarding agent is preferred.

The percentage of the wood fibers 11 may range from 40% to 80%. The amount of calcium chloride used in the wood fiber plate 10 may be in a range of about 0.1% to about 4%. The amount of the fire-retarding agent may range from about 0.1% to about 4%. The percentage of the concrete cement may range from about 16% to 56%. In a preferred embodiment, the percentages of the wood fibers 11, calcium chloride, the fire-retarding agent, and the concrete cement are 60%, 2%, 2% and 36%, respectively.

The cement layer 20 has an inner side connected face-to-face with an inner side of the wood fiber plate 10. The cement layer 20 includes a mixture of a concrete cement and a resin, and a reinforcing web 21. The percentage of the concrete cement may range from about 96.5% to about 99.5%. The percentage of the resin may be in a range of about 0.5% to about 3.5%. In a preferred embodiment of the present invention, the percentages of the concrete cement and the resin are 98% and 2%, respectively. The resin useful for mixing with the concrete cement may be any suitable resin that can enhance the ability of the cement layer 20 to bond to the wood fiber plate 10. An example of the resin is an epoxy resin.

The reinforcing web 21 is embedded in the cement layer 20 to reinforce the cement layer 20. The reinforcing web 21 may be any reinforcing fabric sheet which can add strength to the cement layer 20. In a preferred embodiment, the reinforcing web 21 has a knitted or woven structure formed of natural fibers. Examples of the natural fibers are those obtained from palm and coconut trees.

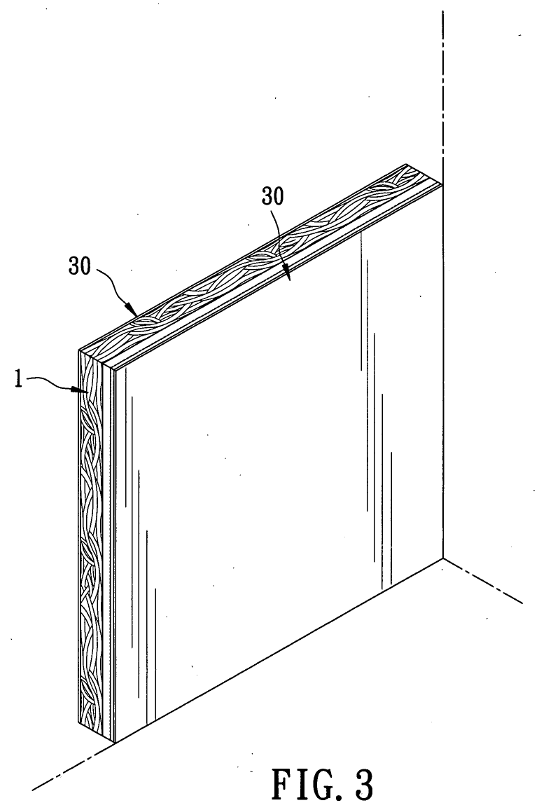

Referring to FIG. 3, there is shown a building wall constructed by using the composite panel 1. In construction, a plurality of the composite panels 1 (only one is shown) are first assembled to form a building wall. After the composite panels 1 are assembled to form the building wall, finishing work may be conducted by applying a thin layer 30 of a concrete cement or a paint to two opposite wall surfaces of the building wall.

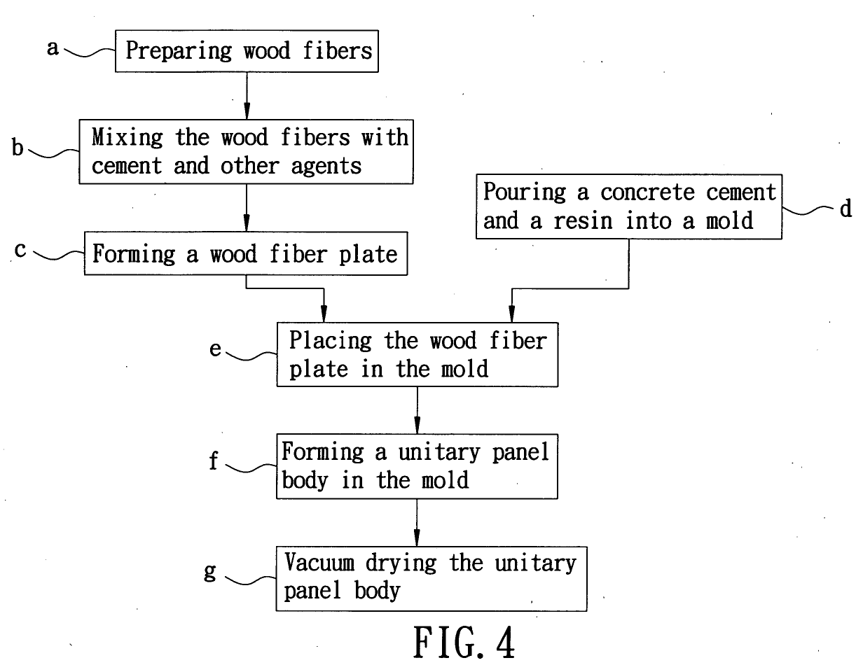

Referring to FIG. 4, a method of making a composite panel 1 according to a preferred embodiment of the present invention is shown to include the following steps:

In step (A), the wood fibers 11 are prepared. The preparation may be made by obtaining the wood fibers 11 from raw soft woods, or recycled woods in a conventional manner.

In step (B), the wood fibers 11 are mixed with calcium chloride, the fire-retarding agent, and a concrete cement. The calcium chloride is used as an antiseptic agent. The fire-retarding agent can increase the firing-point of the wood fibers 11, whereas the concrete cement is used as a binder.

In step (C), the wood fibers 11 which have been mixed with calcium chloride, the fire-retarding agent and a concrete cement are pressed and formed into the wood fiber plate 10.

In step (D), a mixture of the concrete cement and the resin is poured into a mold. During the pouring of the mixture, the reinforcing web 21 is embedded in the mixture.

In step (E), after the mixture of the concrete cement and the resin has been poured into the mold, the wood fiber plate 10 is placed into the mold over the mixture of the concrete cement and the resin. Since the concrete cement and the resin are binders, they are bonded to the wood fiber plate 10, thus forming a unitary panel body in step (F). In step (G), the unitary panel body formed in the mold is sent to a vacuum furnace (not shown) for vacuum drying. Finally, the composite panel 1 which has fire-retarding, sound-absorbing and shock-resisting properties is formed.

The composite panel according to the present invention provides the following advantages:

Due to the wood fiber plate 10 which can absorb noise and sound and which has low heat conductivity, and due to the cement layer 20 which has a high firing-point and a high hardness, the composite panel 1 is sound-resistant, heat-resistant, and fire-resistant.

Since the composite panel 1 is made mainly from the wood fibers 11 and the concrete cement, the cost thereof is much lower than the conventional calcium silicate panel.

The composite panel 1 is lighter and thinner than bricks and concrete panels.

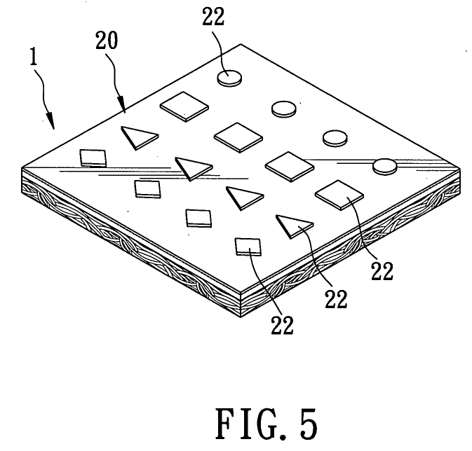

Referring to FIG. 5, according to another preferred embodiment of the present invention, the composite panel 1 may be provided with decorative protrusions 22 formed on an outer surface of the a cement layer 20 to enhance the appearance of the composite panel 1.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A composite panel comprising:
a wood fiber plate including wood fibers, calcium chloride, a fire-retarding agent, and a concrete cement;
a cement layer connected to said wood fiber plate and containing a concrete cement and a resin.

2. The composite panel of claim 1, further including a reinforcing web embedded in said a cement layer.

3. The composite panel of claim 2, wherein said reinforcing web includes a natural organic fiber.

4. The composite panel of claim 3, wherein said natural organic fiber is obtained from palm and coconut trees.

5. The composite panel of claim 2, wherein said reinforcing web has a knitted or woven structure.

6. The composite panel of claim 1, wherein the cement layer has an outer surface formed with a plurality of decorative protrusions.

7. A method of making a composite panel, comprising:
(a) preparing wood fibers;
(b) mixing the wood fibers with calcium chloride, a fire-retarding agent, and a concrete cement to form a mixture;
(c) forming the mixture into a wood fiber plate;
(d) pouring a mixture of a concrete cement and a resin into a mold;
(e) placing the wood fiber plate into the mold over the mixture of the concrete cement and the resin; and
(f) forming the wood fiber plate and the mixture of the concrete cement and the resin into a unitary panel body in the mold.

8. The method of claim 7, further comprising the step of vacuum drying the unitary panel body after step (f).

9. The method of claim 7, further comprising embedding a reinforcing web in the mixture of the concrete cement and the resin during step (d).
